(19) United States
(12) Patent Application Publication
(10) Pub. No.: US 2004/0060223 A1
(43) Pub. Date: Apr. 1, 2004

(54) Make it real (plastic, inflatable, simulated turkey feed, hunting decoy)

(76) Inventor: Ronald W. Mercier, Williamstown, VT (US)

Correspondence Address: RONALD W. MERCIER, P.O. BOX 153, MONTPELIER, VT, 05601, US

(21) Appl. No.: 10/259,694

(22) Filed: Sep. 30, 2002

(51) Int. Cl. A01M 31/06

(52) U.S. Cl. 43/2

(57) ABSTRACT

The “Make it Real” decoy is a plastic, inflatable, simulated turkey feed, hunting decoy which simulates piles of turkey feed but is lightweight and easy to carry. It has a small valve and cap that enables it to be inflated by a person blowing into the valve and is weighted.

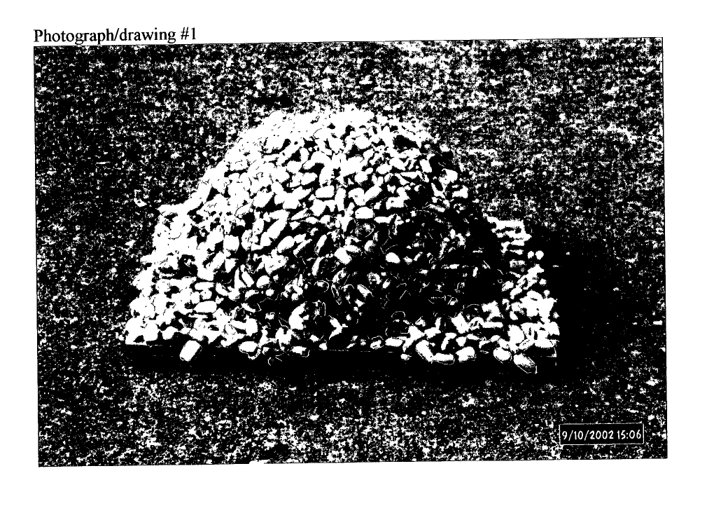

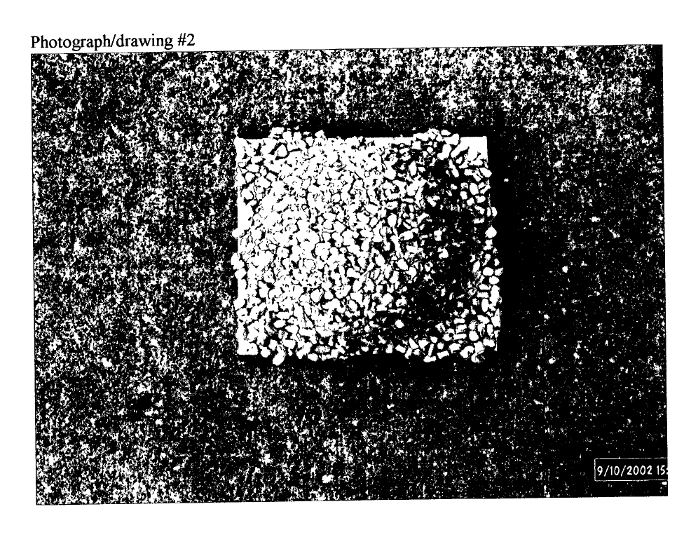

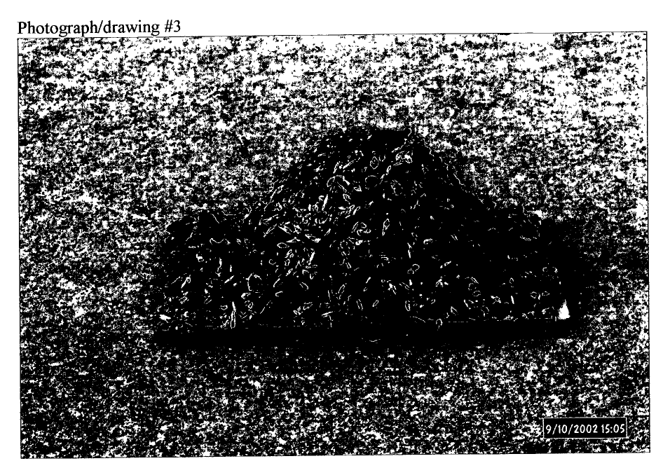

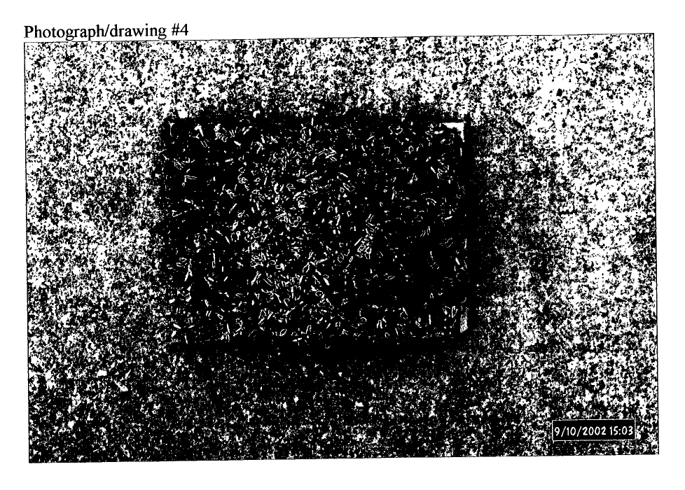

### SPECIFICATION

The invention is a plastic, inflatable, simulated turkey feed, hunting decoy. It is approximately 4 inches in height, approximately 8 inches in width at the base and 10 inches in length at the base and has a small valve and cap that enables it to be inflated by a person blowing into the valve and then placing the cap into the valve to retain the air in the decoy.

### BACKGROUND OF THE INVENTION

The field of endeavor to which the invention pertains is hunting. While hunting turkeys the inventor places several decoy turkeys near each other to lure wild turkeys into a close proximity to the hunter. Many Turkey hunters use this technique. The inventor has observed that Turkeys have excellent eyesight and by placing piles of feed (corn or sweet feed) by the decoy Turkeys it has increased the likelihood of wild turkeys being drawn close to the turkey decoys probably because it conveys the illusion that the decoys are feeding. The “Make it Real” decoy simulates piles of feed but is lightweight and easy to carry.

### BRIEF SUMMARY OF THE INVENTION

The hunter carries their turkey decoys to their hunting area and the inventor has invented the “Make it Real” inflatable, turkey feed, hunting decoy which the hunter can easily carry to their hunting area. The hunter then inflates the “Make it Real” decoy by placing their mouth on the valve and blowing air into the “Make it Real” decoy until it is inflated and then places the cap into the valve to retain the air in the “Make it Real” decoy. The “Make it Real” decoy is weighted so that wind will not carry it away from the hunting area.

### DETAILED DESCRIPTION OF THE INVENTION

The invention is a plastic, inflatable, simulated turkey feed, hunting decoy. It is approximately 4 inches in height, approximately 10 inches in width and 10 inches in length and has a small valve and cap that enables it to be inflated by a person blowing into the valve and then placing the cap into the valve to retain the air in the decoy. It is vinyl plastic and produced by film extrusion. It has a weighted bottom to reduce the chance of the wind moving it from the location that the hunter places it at.

Photograph/drawing number #1 shows the corn feed decoy from the side view.

Photograph/drawing number #2 shows the corn feed decoy from the top view.

Photograph/drawing number #3 shows the sweet feed decoy from the side view.

Photograph/drawing number #4 shows the sweet feed decoy from the top view.

1. What I, Ronald W. Mercier, claim as my invention is the inflatable, simulated turkey feed, hunting decoy.
